(19) United States
(12) Patent Application Publication
(10) Pub. No.: US 2009/0239009 A1
(43) Pub. Date: Sep. 24, 2009

(54) BAG HAVING CONTROLLED OXYGEN-PERMEABILITY

(75) Inventor: Shigeki Tanaka, Osaka-shi (JP)

Correspondence Address: FISH & RICHARDSON P.C., P.O. BOX 1022, MINNEAPOLIS, MN, 55440-1022, US

(73) Assignee: Toyo Boseki Kabushiki Kaisha, Osaka-shi (JP)

(21) Appl. No.: 12/089,217

(22) PCT Filed: Sep. 9, 2006
(86) PCT No.: PCT/JP2006/319454

§ 371 Date: May 6, 2008

(30) Foreign Application Priority Data
Oct. 4, 2005 (JP) 2005-291119

(51) Int. Cl. B32B 3/26; B32B 27/00

(52) U.S. Cl. 428/35.2

(57) ABSTRACT

The present invention proposes a bag having controlled oxygen permeability, which is excellent in flexibility, wear resistance, heat resistance and heat-sealing property.

Disclosed is a bag having controlled oxygen permeability, which includes a nonwoven fabric and a porous film that are jointed and integrated, wherein the nonwoven fabric consists of a polyester fiber containing any one of polybutylene terephthalate, polypropylene terephthalate or polylactic acid as a main component, the porous film has Frazier air permeability of 0.05 to 2 cc/cm²·sec, and end portion of the bag is heat-sealed.

### TECHNICAL FIELD

The present invention relates to a bag which is flexible and excellent in heat-sealing property, and has controlled oxygen permeability.

### BACKGROUND ART

A product, which comprises a component reacting with oxygen such as a freshness-keeping agent (hereinafter called as an oxygen reactive component) wrapped in a bag-like article (hereinafter called as a package of oxygen reactive component), is widely used even among general consumers. It has also been studied to decompose components with foul smell or treat diseases by an exothermic reaction, by selecting the oxygen reactive component. Here, design of the bag-like article wrapping the oxygen reactive component exerts an extremely critical effect in dictating the performance and the life of the product. Particularly, the oxygen permeability of the bag-like article is controlled by the oxygen permeability of the material itself and the sealed state at the end portion of the bag-like article.

For this reason, a film is often used as a material of the bag-like article for the package of oxygen reactive component. However, when an attempt is made for forming a flawless and tightly sealed state at the end portion of the bag-like article, it is unavoidable to use a thick film. Such an attempt puts a limit on the range of oxygen permeability of the film itself to be employed, and the film is inferior in texture and flexibility giving a severe discomfort when it is used in contact with human body.

It is known that a laminate of a film and a nonwoven fabric prevents the sticking tactile impression which is typical of a film, and the stiff texture, and provides a fabric-like tactile impression as well as a tear resistance of the packaging layer (please refer to Patent Document 1, for example).

However, in designing the nonwoven fabric for a packaging bag, there were problems that the stiff texture increased when an attention was paid to tear resistance and fluff prevention of the packaging bag, while the fabric fluffed and shape stability declined when an attention was paid to maintain the fabric-like tactile impression and flexibility.

Use of a nonwoven fabric made from a polymer material with a low melting point such as polyethylene, gives a soft texture and improves the sealing property of the nonwoven fabric itself at the low temperature, but brings about a problem that it limits the temperature and processing velocity for laminating the film and the nonwoven fabric since the heat resistance and strength of the nonwoven fabric are insufficient.

Polyethylene terephthalate (PET) is widely used for bottles as a material excellent in recycling property, but the texture is hard in general and the application is limited. There was also a problem of inferiority in the heat-sealing property. Nylon 6 has a soft texture, but had such problems as the easy discoloration into yellow which markedly diminishes the product value in applications for general consumers, and the likeliness of containing harmful components in its combustion gas.

As stated above, to date, the bag-like article which is flexible and excellent in texture and has controlled oxygen permeability, has not yet been obtained.

Patent Document 1: Japanese Unexamined Patent Publication No.

### DISCLOSURE OF THE INVENTION

### Problems to be Solved by the Invention

The present invention has been made in view of the problems of the prior art, and the object thereof is to propose a bag-like article which is flexible and excellent in texture and has controlled oxygen permeability.

### Means for Solving the Problems

The inventors of the present invention had intensively studied to solve the above problems, and found that flexibility, durability and heat-sealing property can be improved by using a flexible polyester with a reduced modulus as the fiber constituting the nonwoven fabric on the surface layer of the packaging material, thus leading to completion of the present invention.

The present invention provides (1) a bag having controlled oxygen permeability comprising a laminate of a nonwoven fabric and a porous film that are jointed and integrated, wherein the nonwoven fabric consists of a polyester fiber containing any one of polybutylene terephthalate, polypropylene terephthalate or polylactic acid as a main component, Frazier air permeability of the laminate is from 0.05 to 1.5 cc/cm², and end portion of the bag is heat-sealed, (2) the bag having controlled oxygen permeability according to (1), wherein the polyester fiber contains a crystalline component and an amorphous component, (3) the bag having controlled oxygen permeability according to (2), wherein the crystalline polyester component is polybutylene terephthalate, and the amorphous polyester component comprises a copolyester containing any one of cyclohexane dimethyl, butanediol or neopentyl glycol as a component, (4) the bag having controlled oxygen permeability according to any one of (1) to (3), wherein the porous film contains 20 to 60% by weight of a calcium carbonate particle and has an apparent ratio of hole area of from 20 to 95%, and (5) the bag having controlled oxygen permeability according to any one of (1) to (3), wherein the porous film comprises an elastic copolyolefin containing polyethylene, and contains 0.2 to 3 holes having an apparent diameter of 0.5 mm or less per 1 cm.

### Effects of the Invention

The bag having controlled oxygen permeability of the present invention excels in flexibility and texture, has less fluff, and can control oxygen permeability with high precision, and is of advantage in giving no discomfort to users particularly in the application of being used in contact with human body.

### BEST MODE FOR CARRYING OUT THE INVENTION

Hereinafter, the present invention will be described in detail.

The bag having controlled oxygen permeability of the present invention comprises a laminate of a nonwoven fabric and a porous film that are jointed and integrated, wherein the nonwoven fabric consists of a polyester fiber comprising any one of polybutylene terephthalate, polypropylene terephthalate or polylactic acid as a main component, Frazier air permeability of the laminate is from 0.05 to 1.5 cc/cm², and the end portion of the bag is preferably heat-sealed. The particularly preferred Frazier air permeability is from 0.2 to 1.0 cc/cm²·sec.

When the laminate with the Frazier air permeability falling within the above range is used for a bag-like article that wraps the oxygen reactive component, it is excellent in the balance between the exhibited effect and the product life, and the Frazier air permeability is mainly controlled by the film design. However, within the limited range of the air permeability, the air permeability fluctuates greatly according to a flaw caused by external stimulation or the like. In use of the film alone, the oxygen permeability fluctuates greatly due to a damage incurred from external contact, moreover, the texture is poor and discomfort is caused when the film is in contact with human body.

Accordingly, the inventors of the present invention found that, by using a nonwoven fabric comprising a polyester fiber which contains any one of polybutylene terephthalate, polypropylene terephthalate or polylactic acid as a main component, as a surface material or a reinforcing material, a bag can be obtained without damaging the texture, and since the temperature upon sealing the bag can be properly adjusted depending on the property of the film, the film can be tightly heat-sealed, and the nonwoven fabric itself is converted into a film at the heat-sealing portion and serves as a protection/reinforcing material, as a result, the oxygen permeability can be controlled with high precision.

Frazier air permeability of the laminate used for the bag of the present invention can be controlled by the design of the film as stated above, and it can also be controlled by applying print on the surface of the nonwoven fabric. The nonwoven fabric used for the bag of the present invention excels in the printing property since it contains any one of polybutylene terephthalate, polypropylene terephthalate or polylactic acid as a main component, and this also makes it easier to control oxygen permeability.

In the bag having controlled oxygen permeability of the present invention, which comprises a nonwoven fabric consisting of a polyester fiber, the nonwoven fabric preferably consists of a polyester fiber containing any one of polybutylene terephthalate, polypropylene terephthalate or polylactic acid as a main component and having a resin composition containing 0.5 to 50% by weight of an amorphous polyester component having a glass transition temperature of 20° C. or higher in a crystalline polyester component.

The present invention is made based on the findings of the inventors that by comprising the amorphous polyester component, not only fluff and the like are prevented, but also the nonwoven fabric is converted into a film-like product at the heat-sealed portion with an improved sealing property and the damage of the oxygen permeable film incurred from heat-sealing (thermocompression bonding) can be compensated.

Even for a homopolymer not going through copolymerization, it is possible to ensure required properties such as flexibility by properly adjusting production conditions of the fiber. In view of durability and the like, the nonwoven fabric is preferably prepared by spreading a continuous fiber with a fineness of 0.5 to 5 dtex in a single filament unit, compression bonding it in dot forms and allowing the portions squashed by thermocompression bonding to be substantially individually independent, and is preferably jointly integrated in a forming area ratio of thermocompression bonding portion of 5 to 60%.

The crystalline polyester of the present invention is a polyester which shows a reaction peak originated from crystallization or an endothermic peak originated from crystalline melting, measured by a differential scanning calorimeter (DSC). Examples thereof include polyethylene terephthalate and polybutylene terephthalate, in which the acid component is terephthalic acid and the glycol component is ethylene glycol or 1,4-butanediol, a copolymer comprising terephthalic acid and other acid component as the acid component, and a copolymer comprising ethylene glycol and other glycol component as the glycol component.

More specifically, the other acid component includes aromatic dicarboxylic acid such as isophthalic acid, diphenylether-4,4′-dicarboxylic acid, naphthalene-1,4-dicarboxylic acid and naphthalene-2,6-dicarboxylic acid; aliphatic dicarboxylic acid such as oxalic acid, succinic acid, adipic acid, sebacic acid and undecadicarboxylic acid; and alicyclic dicarboxylic acid such as hexahydroterephthalic acid, but is not limited thereto. On the other hand, the other glycol component is exemplified by aliphatic glycol such as propylene glycol and neopentyl glycol; alicyclic glycol such as cyclohexane dimethanol; and aromatic dihydroxy compound such as bisphenol A, but is not limited thereto. The preferred crystalline polyester of the present invention includes the polyester in which the acid component is an aromatic dicarboxylic acid and the glycol component is a linear diol. Examples thereof include polyethylene terephthalate, polybutylene terephthalate, polyethylene naphthalate and polybutylene naphthalate. The most preferred crystalline polyester of the present invention is polybutylene terephthalate, which provides flexibility and moldability and retains heat resistance.

The amorphous polyester of the present invention is a resin which has no clear crystallization or crystalline melting peak, measured by DSC. The glass transition temperature (Tg) of the amorphous polyester is a value obtained from a transition point of latent heat upon raising temperature at a temperature rising rate of 20° C./min using DSC, and is 20° C. or higher in the present invention. It is not preferred to be lower than 20° C., since the heat resistance is inferior. In other words, in order to enhance heat resistance and impact resistance, the amorphous polyester with high Tg is necessary. As the amorphous polyester, the polyester whose dicarboxylic acid is an aromatic dicarboxylic acid, for example, terephthalic acid and 2,6-naphthalenedicarboxylic acid, is preferred. However, within the range where the above Tg can be retained at 20° C. or higher, in addition to the aromatic dicarboxylic acid as a main component, the amorphous polyester may contain one or more kinds of aliphatic dicarboxylic acids such as oxalic acid, succinic acid, adipic acid, sebacic acid and undecadicarboxylic acid; and alicyclic dicarboxylic acids such as hexahydroterephthalic acid. The preferred dihydroxy compound component is aliphatic glycol, and examples thereof include ethylene glycol, propylene glycol, 1,4-butanediol, neopentyl glycol and hexamethylene glycol, and examples of the aromatic dihydroxy compound include bisphenol, 1,3-bis(2-hydroxyethoxy)benzene and 1,4-(hydroxyethoxy)benzene. These compounds can be used alone or used in combination of two or more kinds. The particularly preferred amorphous polyester component of the present invention is a copolyester comprising terephthalic acid as the acid component and 50 to 85 mol % of ethylene glycol (or 1,4-butanediol) and 15 to 50 mol % of neopentyl glycol (or 1,4-cyclohexanedimethanol) as the glycol component. With the composition, the amorphousness is retained and Tg can be made at 70° C. or higher.

In the present invention, in view of compatibility since the base resin is polyester, the amorphous polymer is preferably a polyester in many cases.

In one preferred embodiment, the nonwoven fabric used as a reinforcing material for the bag disclosed in the present invention having controlled oxygen permeability is constituted by a fiber consisting of a resin composition comprising 0.5 to 50% by weight of the amorphous polyester component with Tg of 30° C. or higher in the above crystalline polyester component. When the content of the amorphous polyester component is less than 0.5% by weight, impact resistance of the fiber is prone to decline, and fluff is prone to increase due to wear or the like. Moreover, the heat-sealing property is prone to decline. When the content of the amorphous polyester component exceeds 50% by weight, heat shrinkage increases and shape stability under heat declines and therefore, it is not preferable. The content of the amorphous polyester component is preferably from 2 to 20% by weight, more preferably from 5 to 15% by weight, in the present invention.

The crystalline polyester and the amorphous polyester may be supplied to a spinning machine after they are mixed and dried, or may be supplied to a spinning machine after they are pelletized and dried. In addition, they can be supplied to two extruders separately, and then melt-blended.

The fiber constituting the nonwoven fabric which is used as a constituent material of the bag disclosed in the present invention having controlled oxygen permeability, is a fiber with a fineness of 0.5 to 5 dtex. Preferably, the initial tensile resistance (IS) of a single filament is from 5 to 20 cN/dtex.

The fineness of the single filament is preferably from 0.5 to 5 dtex in the present invention. When the fineness is less than 0.4 dtex, the tension of the nonwoven fabric declines and it becomes difficult to retain the bag shape, sometimes leading to the problem of deformation of the bag and therefore, it is not preferable. When the fineness exceeds 6 dtex, the texture becomes hard and the bag may get stiff in some cases and therefore, it is not preferable. A preferred fineness of the single filament is from 0.5 to 4 dtex, more preferably from 1 to 3 dtex in the present invention.

IS of the single filament is preferably from 5 to 20 cN/dtex in the present invention, in order to maintain softness, wear resistance and shape stability. When IS is less than 5 cN/dtex, there are cases where wear resistance and shape stability are inferior. When IS exceeds 20 cN/dtex, sometimes rigidity increases and softness decreases. The preferred range of IS is from 6 to 15 cN/dtex, more preferably from 8 to 12 cN/dtex, in the present invention.

It is not always preferred in the present invention that the nonwoven fabric consists of short fibers since strength and wear resistance of the nonwoven fabric tend to decrease. However, it is preferred to use the nonwoven fabric which is made by combining a short fiber web into a spunlace or spunbond nonwoven fabric and then subjecting to a spunlace processing. Examples of the preferred nonwoven fabric used in the present invention include spunbond nonwoven fabric, tow opening nonwoven fabric, and melt blow nonwoven fabric made from a continuous fiber, and particularly preferred is the spunbond nonwoven fabric.

The nonwoven fabric used in the present invention is preferably made by compression bonding it in dot forms and allowing the portions squashed by thermocompression bonding to be individually independent, and is preferably jointly integrated in a forming area ratio of thermocompression bonding of 5 to 40%.

It is not preferred that spread of the fiber is insufficient, because plaque of the nonwoven fabric becomes distinguishable, and homogeneity of texture of the bag is inferior.

In the present invention, the nonwoven fabric used as a constitute material of the bag is preferably prepared by spreading the fiber, compression bonding it in dot forms and allowing the portions squashed by thermocompression bonding to be individually independent, and is preferably jointly integrated in a forming area ratio of thermocompression bonding of 5 to 40%. In the nonwoven fabric morphogenesis made by means of a mechanical confounding treatment through a needle punching method, damage of the fiber is severe, and strength of the nonwoven fabric declines, sometimes causing tear upon using the bag. Therefore, it is preferred to perform post-processing to provide a sealing treatment.

Thermocompression bonding is performed in dot forms, and is an essential factor for retaining thickness of the entire nonwoven fabric and allowing free deformation to be done easily to maintain softness, by making the portions squashed by thermocompression bonding individually independent. If the portions squashed by thermocompression bonding are continuous, because free flexure of surface is restricted, flexibility is declined over the entire nonwoven fabric and the bag becomes stiff while in use. In order to retain integrated shape and secure wear resistance, the thermocompression bonding area needs to be 5% or more, but it is not preferred that the bonding area exceeds 40% because of decline in softness in some cases. The preferred thermocompression bonding area is from 8 to 30%, more preferably from 10 to 27%, in the nonwoven fabric used in the present invention. The pattern of the independent dots is not particularly limited, but it is preferably a thread pattern, polka dotted pattern, oval pattern, woven pattern or cross-shaped pattern. Particularly, an embossed woven pattern is preferred. The area of the independent squashed portion under thermocompression bonding is not particularly limited, but is preferably 2 mm² or less, and more preferably 1 mm² or less. In addition, shape stability may be unsatisfactory when the area is less than 1 mm², in the case where the fineness is large, and therefore, it is more preferred that the area is from 0.1 to 1 mm² in the case where the fineness is 4 dtex or more.

Through the integration by thermocompression bonding, surface smoothness, and shape of the nonwoven fabric with compressed filling are maintained, and by synergetic effect of the improvement in durability due to the composition of fiber and mechanical properties, the nonwoven fabric with good flexibility and wear resistance as well as excellent heat-sealing property is obtained. The laminate-processed nonwoven fabric enables to exhibit softness, excellent durability and shape stability, and function of controlling oxygen permeability, after a reactant being inserted in it, thermoformed and packed, and the pack being removed before use.

The cross section of the fiber constituting the nonwoven fabric which is a constituent material of the present invention, is not particularly limited, but it is preferred to use a fiber with a circular cross section. Fibers with atypical cross sections are inferior to a fiber with a circular cross section in the strength when being formed, but can be usable by optimizing production conditions.

Strength and elongation, being as mechanical properties of the fiber constituting the nonwoven fabric which is a constituent material of the present invention, are not particularly limited. However, when strength of a single filament is too low, strength of the nonwoven fabric declines and wear resistance also declines in some cases. The preferred strength is 3 cN/dtex or more, more preferably 3.4 cN/dtex or more. The preferred elongation is from 25 to 150%, more preferably from 30 to 120%, since dimensional stability of the nonwoven fabric sometimes declines when the elongation is too high, while wear resistance sometimes declines when it is too low.

Basis weight of the nonwoven fabric which is a constituent material of the bag of the present invention, is not particularly limited. However, it is preferred to select an appropriate range, since when the basis weight is too low, coating function to the reactant is lost or adhesive used for laminating the fabric with the film runs off in some cases, while when it is too high, the texture becomes stiff. The basis weight is preferred to be from 10 to 50 g/m², more preferably from 15 to 40 g/m², and most preferably from 20 to 40 g/m², when the nonwoven fabric is applied to the present invention.

Thickness of the nonwoven fabric is not particularly limited in the present invention, but when the fabric is applied to the bag of the present invention, the thickness is preferably from 0.1 to 0.5 mm, which is thick enough to cover the reactant, and the thickness is more preferably from 0.2 to 0.4 mm.

Mechanical properties of the nonwoven fabric are not particularly limited in the present invention. However, when the fabric is applied to the present invention, since sometimes the fabric is torn if strength per basis weight is too low, the strength per basis weight of 0.5 N/5 cm/(g/m²) or more with which the fabric isn't torn is preferred, and 1.0 N/5 cm/(g/m²) or more is more preferable. The preferred elongation is 40% or less, and more preferably 30% or less in view of the shape stability, since excessively high elongation may cause troubles due to elongation during a step of the molded, or may damage the shape stability of the molded. The tear strength per basis weight especially to prevent the tear due to being hooked is preferably 0.15 N/5 cm/(g/m²) or more, and more preferably 0.2 N/5 cm/(g/m²) or more. Bending resistance, a measure for softness, is preferably 70 mm or less, and more preferably 60 cm or less.

Thermal property of the nonwoven fabric which is a constituent material of the bag is not particularly limited in the present invention. However, dry heat shrinkage rate at 180° C., as a shrinkage rate that withstands the processing step and use as a bag packaging material, is preferably 5% or less, more preferably 3% or less, and most preferably 1.5% or less.

Air permeability of the nonwoven fabric used as a constituent material of the present invention is not particularly limited, but it is preferred to be from 20 to 250 cc/cm²/sec, and more preferably from 30 to 100 cc/cm²/sec.

Hereinafter, an example will be shown for a production method of the nonwoven fabric of the present invention.

90 parts of the crystalline polyester and 10 parts of the amorphous polyester were mixed and dried, wherein the crystalline polyester is, for example, polybutylene terephthalate with an intrinsic viscosity of 0.93, and the amorphous polyester is, for example, a copolyester with Tg of 79° C. and an intrinsic viscosity of 0.72 which consists of neopentyl glycol component and ethylene glycol component as a glycol component and terephthalic acid as an acid component. The dried polyester mixture was supplied to a spinning machine and spinning twisted by a conventional method, for example, at a spinning temperature of 260° C., from a nozzle with an orifice diameter Φ of 0.23 mm, at a discharging amount of 0.9 g/min/hole. For example, when a spunbond nonwoven fabric is prepared, the spinning twisted filaments were discharged by an ejector at a speed of 4,500 m/min while being cooled, spread and thrown off onto a receiving net which was moving below at 100 m/min to form a web of being uniformly spread with a basis weight of 50 g/m². The single filament in the web had a fineness of 2 dtex and IS of 35 cN/dtex. The web was then subjected to an embossing processing with an emboss roller which gave a woven pattern and a bonding area of 20%, at 215° C. under a linear pressure of 80 kN/m, followed by winding up, so as to obtain a spunbond non-woven fabric of a long-fiber non-woven fabric. The resultant spunbond nonwoven fabric had a basis weight of 50 g/m², a thickness of 0.3 mm, tensile strengths of 70 N/5 cm in longitudinal direction and 60 N/5 cm in lateral direction, tensile elongation of 26% in longitudinal direction and 38% in lateral direction, tear strength of 16 N in longitudinal direction and 14 N in lateral direction, and dry heat shrinkage rates of 3% in longitudinal direction and 1% in lateral direction.

The spunbond nonwoven fabric was laminated with a thermoplastic resin film having air permeability to form a surface material for a bag.

Examples of the porous film used in the present invention include various polyethylenes such as LDPE (low density polyethylene), LLDPE (linear low density polyethylene), HDPE (high density polyethylene) and metallocene-based catalyst PE; polyolefins such as polypropylene; EVA and copolymerized polyolefins of ethylene, propylene, butene or octene; polyamides; and polyesters. A microporous film having moisture permeability may be used. In view of flexibility, sealing property and cost, films of polyethylene or the copolymerized olefin are preferred. A two-layered or three-layered film may also be used, in view of compatibility to the nonwoven fabric and sealing property in the periphery of the package.

The surface material of the bag used in the present invention is prepared by laminating the nonwoven fabric with the thermoplastic resin film, by heat-sealing, frame laminate or a hot melt adhesive. The laminate can be jointed by whole face junction or partial junction, but partial junction is preferred in view of flexibility. The air permeability of the surface material is provided by opening holes after lamination, or using a porous or microporous film. Air necessary for the reaction is supplied through the air holes, and the quantity of oxygen to be supplied is controlled according to the area and number of the holes. The packaging material with air permeability needs to be used at least on one side, and the other side may use a surface material without air permeability.

The porous film used in the present invention preferably has Frazier air permeability of from 0.05 to 2 cc/cm² sec, more preferably from 0.5 to 1.5 cc/cm²·sec. It is not preferred that the air permeability exceeds 2 cc/cm²·sec, because oxygen permeability is not controlled, so as to complete the reaction of constituents with oxygen early. On the other hand, it is not preferred that the air permeability is low, because it becomes difficult to get an intended reaction rate. The air permeability of the composite of the nonwoven fabric and the film can be controlled by the film itself by selecting the production conditions thereof, but can also be controlled by the nonwoven fabric to be jointed and the quantity of the adhesive.

The porous film is prepared by mixing a foreign matter in a polymer material, followed by generating voids upon stretching. The foreign matter can be other polymer material with a different solubility parameter, or can be an inorganic particle. A mixture containing 20 to 60% by weight of calcium carbonate particles is preferably inflated or stretched to generate voids. Herein, the apparent ratio of hole area preferably accounts for 20 to 95%. When the content of calcium carbonate is less than 20%, it is difficult to make holes that penetrate from the surface of the film to the other side, and thus air permeability is hardly controlled. While when the content of calcium carbonate exceeds 60%, flaws such as fish eye occur upon film processing, and the film formation property declines markedly and therefore, it is not preferable. The content of calcium carbonate is preferably between 45 and 55%. In one preferred embodiment, various stabilizers such as an anti-oxidant and an ultraviolet absorber are added, if necessary.

Another production method of the porous film is an extrusion laminating method, which includes extruding the polymer from a T-die and contacting it with the nonwoven fabric immediately thereafter. In this method, the polymer becomes sticking to the nonwoven fabric, and by physical adsorption or an anchor effect, integration is possible without using an adhesive. The nonwoven fabric is preferably subjected to a corona treatment in advance, in order to enhance the adhesion of the film and the nonwoven fabric, and in another preferable embodiment, the nonwoven fabric is preheated to 50 to 130° C. to enhance adhesion. It is possible to generate pinholes in the film formed by the extrusion laminating method by blending, but the air permeability is not easily controlled. Therefore, it is particularly preferred to make holes by contacting the film to a heated needle or the like. The diameter and pitch of the needle are properly adjusted according to the intended air permeability. The density of the hole is preferably 0.2 to 3 holes per 1 cm. The apparent diameter of the hole is preferably 0.5 mm or less in order to prevent the content in the bag from dropping. Even if the diameter of the needle is larger than 0.5 mm, the size of the hole can be lessened due to elastic recovery when the film is an elastic material. The film material is preferably an elastic material such as a block copolymer of octene and polyethylene, or a copolymer whose structure is controlled by a metallocene catalyst. In many cases, these elastic materials enable to prevent abnormal noise, which occurs when a bag made of the materials is bent.

The bag having controlled oxygen permeability of the present invention may be usually used in a way that the film side of the surface material having air permeability is used as an inner side for accommodating the reaction composition, and the peripheral region is sealed. For example, the reaction composition consists of an organic compound, a salt of inorganic compound, an iron powder, active carbon and water. After accommodating the reaction composition in the packaging material, the peripheral region of the packaging material is sealed in order to prevent the powder from leaking. Since the nonwoven fabric is used, the sufficient seal molding can be made by conventional heat-sealing. However, if necessary, in a range where flexibility, wear resistance, shape stability and heat retaining property are not damaged, the sealing using an adhesive such as a hot melt adhesive may be performed.

In the present invention, if necessary, a nonwoven fabric which is provided with pigments for spun-dyeing or various reforming agents by kneading them into the resin or by post-processing may be used.

The bag of the present invention prepared as above is flexible, durable and heat resistant, and excels in shape stability.

Incidentally, examples of the present invention are not limited thereto.

Hereinafter, examples of the present invention will be shown. The present invention is not limited to the examples.

### EXAMPLES

The present invention will be specifically described by using Examples and Comparative Examples. Characteristic values in Examples and Comparative Examples were measured by the following methods.

### <Crystallinity and Amorphousness>

Using a differential scanning calorimeter (DSC), the temperature was raised from 20° C. to 300° C. at a rate of 20° C./min, retained at 300° C. for 5 minutes, and lowered from 300° C. to 20° C. at a rate of 20° C./min for measuring calories. Based on the absorption reaction pattern, the reaction peak originated from crystallization and the endothermic peak originated from crystalline melting were examined. The pattern with clear absorption reaction peaks was determined as the crystalline polyester, and that without clear absorption reaction peak was determined as amorphous polyester.

### <Glass Transition Temperature (Tg)>

The polyester, which was molten under heat of 300° C. for 5 minutes and then put into water for quenching, was used as the sample. Tg was determined as the value obtained from the transition point of latent heat upon raising the temperature at a rate of 20° C./min with the above DSC.

### <Fineness of Single Filament>

A specimen, which was sampled from the arbitrary portion of the nonwoven fabric, was set on an optical microscope equipped with a digital micrometer eyepiece device, which enables to observe the cross section of the specimen. Regarding arbitrary 50 fibers cut at nearly a right angle in the direction across the axis of the fiber, the lengths of long axis and short axis at the cross section of the fiber were measured, the cross section area of each fiber was calculated, and the mean value of the cross section areas was used as the cross section area. Separately, the density of the fiber was calculated, and the fiber weight of 10,000 m long was calculated.

### <Intrinsic Viscosity>

A strip of the nonwoven fabric was sampled from the arbitrary portion of the nonwoven fabric, dissolved in the mixture solvent of tetrachloroethane/parachlorophenol (weight ratio: 40 parts/60 parts) in an amount of 1 g/100 ml, and measured with a viscosity tube in an atmosphere at 30° C. The intrinsic viscosity (dl/g) was calculated in conversion to 0% concentration.

### <Initial Tensile Resistance>

The initial tensile resistance was measured in accordance with the method of JIS-L-1015 (1999).

### <Thickness>

The thickness was measured in accordance with the method of JIS-L-1906 (2000).

### <Basis Weight (Mass per Unit Area)>

The basis weight was measured in accordance with the method of JIS-L-1906 (2000).

### <Apparent Density>

The apparent density per 1 m³ (kg/m³) was calculated from the basis weight and the thickness measured by the above methods.

### <Frazier Air Permeability>

Frazier air permeability was measured in accordance with the method of JIS-L-1906 (2000).

### <Tensile Strength (Strength) and Elongation (Elongation Rate) of Nonwoven Fabric>

The tensile strength and the elongation were measured in accordance with the method of JIS-L-1906 (2000). The width was 5 cm.

### <Heat-Sealing Property>

Adhesion was compared by using a commercially available heat-sealer (Auto Sealer FA-450-5w, manufactured by Fujiimpulse Co., Ltd.).

### <Wear Evaluation>

Sensory evaluation was performed on the following items, under the condition that 10 examinees wore the prepared bags in their pockets before heading off to work in the morning, and took the bags out after wearing them for 12 hours or more. The bag was rated as follows: touch: good ◯, bad x; flexibility: soft ◯, stiff x; fluff: not exist ◯, exist x; fuzz: not exist ◯, exist x; deformation: not exist ◯, exist x; tear: not exist ◯, exist x; sustainability of warmth: 12 hours or more ◯, less than 12 hours x. When over half of the items was rated as ◯, the bag was rated as superior, while when over half was rated as x, the bag was rated as inferior.

### Production Example 1 of Nonwoven Fabric

A dry polyester mixture, which contained 87 parts of polybutylene terephthalate with an intrinsic viscosity of 0.94 serving as a crystalline polyester, and 13 parts of a copolyester with Tg of 78° C. and an intrinsic viscosity of 0.71 serving as an amorphous polyester containing a neopentyl glycol component and an ethylene glycol component as a glycol component and a terephthalic acid component as an acid component, was supplied to a spinning machine, and spinning twisted at a spinning temperature of 260° C., from a nozzle with an orifice diameter Φ of 0.2 mm, at a discharging amount of 0.84 g/min/hole. The filament was discharged by an ejector at a speed of 4,200 m/min while being cooled, and spread and thrown off onto a receiving net which was moving below to form a web of uniformly spread long-fiber with a basis weight of 30 g/m². The single filament in the web had a fineness of 2 dtex and IS of 9 cN/dtex. The web was then processed into independent dots of a woven pattern, subjected to an emboss processing with an emboss roller giving a bonding area of 20%, at 215° C. under a linear pressure of 80 kN/m, followed by winding up, so as to obtain a spunbond non-woven fabric for a bag package use. Properties of the resultant nonwoven fabric are shown in Table 1.

### Production Example 2 of Nonwoven Fabric

A dry polyester mixture, which contained 95 parts of polylactic acid serving as a crystalline polyester, and 5 parts of a copolyester with Tg of 79° C. and an intrinsic viscosity of 0.72 serving as an amorphous polyester containing a neopentyl glycol component and an ethylene glycol component as a glycol component and a terephthalic acid component as an acid component, was supplied to a spinning machine, and spinning twisted at a spinning temperature of 245° C., from a nozzle with an orifice diameter Φ of 0.2 mm, at a discharging amount of 0.7 g/min/hole. The filament was discharged by an ejector at a speed of 2,500 m/min while being cooled, and spread and thrown off onto a receiving net which was moving below, to form a web of uniformly spread long-fiber with a basis weight of 30 g/m². The single filament in the web had a fineness of 2 dtex and IS of 7 cN/dtex. The web was then processed into independent dots of a woven pattern, subjected to an emboss processing with an emboss roller giving a bonding area of 20%, at 185° C. under a linear pressure of 70 kN/m, followed by winding up.

TABLE 1

| | | Production | Production |
|---|---|---|---|
| | | Example | Example |
| | | 1 of | 2 of |
| | | Nonwoven | Nonwoven |
| Item | Unit | Fabric | Fabric |
| Basis weight | g/m² | 30 | 30 |
| Thickness | mm | 0.19 | 0.18 |
| Longitudinal tensile strength | N/5 cm | 51 | 44 |
| Lateral tensile strength | N/5 cm | 29 | 23 |
| Longitudinal tensile elongation | % | 18 | 13 |
| Lateral tensile elongation | % | 32 | 28 |
| Longitudinal tear strength | N/5 cm | 8 | 7 |
| Lateral tear strength | N/5 cm | 7 | 5 |

### Example 1

A copolymer of octene and LDPE was extruded and laminated (thickness: 35 μm) on the opposite side of the embossed surface of the spunbond nonwoven fabric prepared in the above Production Example 1 of Nonwoven Fabric. The film surface was then punched with a needle roller at 1.5 holes/cm² to prepare a packaging material for a bag use with Frazier air permeability of 0.96 cc/cm²·sec. A reaction composition was filled in the packaging material with the film surface as the inner side, and the periphery was heat-sealed to give a bag having controlled oxygen permeability. The heat-sealing property and the finish of form were good. The bag was stored by being tightly sealed with a gas barrier polyethylene film until a test was performed.

The bag having controlled oxygen permeability in Example 1 had smooth tactile, flexibility and moderate touch, since the soft nonwoven fabric was used for the outer surface. There were no fluff and fuzz on the surface nor deformation after wearing it for one day.

### Example 2

A polyamide-based adhesive was spread on the spunbond nonwoven fabric prepared in the above Production Example 2 of Nonwoven Fabric, in an amount of 7 g/m² by a curtain spray method, on which a porous polyethylene film (calcium carbonate: 50% by weight, aperture ratio: 48%, air permeability: 1.2 cc/cm²·sec) was jointed, to give a packaging material for a bag use with Frazier air permeability of 0.85 cc/cm². The resultant bag having controlled oxygen permeability had a good heat-sealing property and the finish of form was good.

The bag having controlled oxygen permeability in Example 2 had smooth tactile, flexibility and moderate touch, since the soft nonwoven fabric was used for the outer surface. There were no fluff and fuzz on the surface nor deformation after wearing it for one day.

### Example 3

A spunbond nonwoven fabric (basis weight: 30 g/m², thickness: 0.18 mm, strength: length/width=38/24, strength: length/width=26/35, tear strength: length/width=6/5) was prepared in the same manner as that in the above Production Example 1 of Nonwoven Fabric, except for using a polybutylene terephthalate homopolymer and adjusting the receiving rate to 3300 m/min.

Using the resultant spunbond nonwoven fabric, a packaging material for a bag use, which had Frazier air permeability of 0.9 cc/cm², was obtained in the same manner as that in Example 1. The packaging material for a bag use was heat-sealed to give a bag having controlled oxygen permeability. The heat-sealing property was somewhat inferior to that in Example 1, but the flexibility and the finish of form were good. Fluff and fuzz on the surface were such extent that there was no practical problem, after wearing it for one day.

### Example 4

A spunbond nonwoven fabric was prepared in the same manner as that in Production Example 1, except for using polypropylene terephthalate with an intrinsic viscosity of 0.95, and adjusting the spinning temperature to 280° C., the discharging amount to 0.8 g/min, the discharging speed to 3,800 m/min, the basis weight of web to 25 g/m², the emboss processing temperature to 220° C., and the linear pressure to 50 kN/m.

Using the resultant spunbond nonwoven fabric, a packaging material for a bag use, which had Frazier air permeability of 0.8 cc/cm², was obtained in the same manner as that in Example 1. The packaging material for a bag use was heat-sealed to give a bag. The heat-sealing property was good, and the finish of form was excellent. The surface of the nonwoven fabric was soft, and the touch was good. There was no problem of fluff and fuzz on the surface, after wearing it for one day.

### Comparative Example 1

A spunbond nonwoven fabric was obtained in the same manner as in Production Example 1, except for using a polyethylene terephthalate resin.

Using the resultant spunbond nonwoven fabric, a packaging material for a bag use, which had Frazier air permeability of 0.9 cc/cm², was prepared in the same manner as that in Example 1. It was then heat-sealed to give a bag. The heat-sealing property was poor, lift was observed at end portions, and the finishing state was not good. The surface of the nonwoven fabric was hard, and had stiff tactile. The bag was inferior in flexibility and touch. After wearing it for one day, there occurred fluff and fuzz on the surface markedly, as well as deformation and tear partially on the packaging material. There was no leakage of the reactant.

TABLE 2

| | | | | Comparative |
|---|---|---|---|---|
| | Example 1 | Example 2 | Example 3 | Example 1 |
| Touch | ∘ | ∘ | ∘ | x |
| Flexibility | ∘ | ∘ | ∘ | x |
| Fluff | ∘ | ∘ | ∘ | x |
| Fuzz | ∘ | ∘ | ∘ | x |
| Deformation | ∘ | ∘ | ∘ | x |
| Tear | ∘ | ∘ | ∘ | x |
| Sustainability | ∘ | ∘ | ∘ | x |
| of warmth | | | | |

### INDUSTRIAL APPLICABILITY

The present invention can provide a bag having controlled oxygen permeability, which is also excellent in flexibility, wear resistance, heat resistance, shape stability and heat retaining property. The bag is usable for a freshness-keeping material using deoxidant, a absorbent material, a tool for hyperthermic treatment and a disposable pocket warmer, and thus the bag greatly contributes to industries.

1. A bag having controlled oxygen permeability, comprising a laminate of a nonwoven fabric and a porous film that are jointed and integrated, wherein the nonwoven fabric consists of a polyester fiber containing any one of polybutylene terephthalate, polypropylene terephthalate or polylactic acid as a main component, Frazier air permeability of the laminate is from 0.05 to 1.5 cc/cm², and end portion of the bag is heat-sealed.

2. The bag having controlled oxygen permeability according to claim 1, wherein the polyester fiber contains a crystalline component and an amorphous component.

3. The bag having controlled oxygen permeability according to claim 2, wherein the crystalline polyester component is polybutylene terephthalate, and the amorphous polyester component comprises a copolyester containing any one of cyclohexane dimethyl, butanediol or neopentyl glycol as a component.

4. The bag having controlled oxygen permeability according to claim 1, wherein the porous film contains 20 to 60% by weight of a calcium carbonate particle and has an apparent ratio of hole area of from 20 to 95%.

5. The bag having controlled oxygen permeability according to claim 2, wherein the porous film contains 20 to 60% by weight of a calcium carbonate particle and has an apparent ratio of hole area of from 20 to 95%.

6. The bag having controlled oxygen permeability according to claim 3, wherein the porous film contains 20 to 60% by weight of a calcium carbonate particle and has an apparent ratio of hole area of from 20 to 95%.

7. The bag having controlled oxygen permeability according to claim 1, wherein the porous film comprises an elastic copolyolefin containing polyethylene, and has 0.2 to 3 holes with an apparent diameter of 0.5 mm or less per 1 cm.

8. The bag having controlled oxygen permeability according to claim 2, wherein the porous film comprises an elastic copolyolefin containing polyethylene, and has 0.2 to 3 holes with an apparent diameter of 0.5 mm or less per 1 cm.

9. The bag having controlled oxygen permeability according to claim 3, wherein the porous film comprises an elastic copolyolefin containing polyethylene, and has 0.2 to 3 holes with an apparent diameter of 0.5 mm or less per 1 cm.
